(19) United States
(12) Patent Application Publication
(10) Pub. No.: US 2024/0203161 A1
(43) Pub. Date: Jun. 20, 2024

(54) EMOTION PREDICTION METHOD BASED ON VIRTUAL FACIAL EXPRESSION IMAGE AUGMENTATION

(71) Applicant: Korea Electronics Technology Institute, Seongnam-si (KR)

(72) Inventors: Ju Hong YOON, Hwaseong-si (KR); Min Gyu PARK, Seoul (KR); Yong Hoon KWON, Seoul (KR); Je Woo KIM, Seongnam-si (KR)

(73) Assignee: Korea Electronics Technology Institute, Seongnam-si (KR)

(21) Appl. No.: 18/535,420

(22) Filed: Dec. 11, 2023

(30) Foreign Application Priority Data
Dec. 14, 2022 (KR) 10-2022-0174501
May 17, 2023 (KR) 10-2023-0063708

(51) Int. Cl. G06V 40/16; G06V 10/774; G06V 10/776; G06V 10/778; G06V 40/40

(52) U.S. Cl. CPC G06V 40/174; G06V 10/774; G06V 10/776; G06V 10/7788; G06V 40/169; G06V 40/40; G06V 10/82

(57) ABSTRACT

There is provided an emotion prediction method based on virtual facial expression image augmentation. The emotion prediction method may acquire a user facial image, may extract a facial expression feature from the acquired user facial image, and may predict a user emotion from the extracted facial expression feature. The emotion prediction method may extract the facial expression feature by using a facial expression recognition network, the facial expression recognition network being an AI model that is trained to receive a user facial image and to extract a facial expression feature. The facial expression recognition network is retrained with virtual facial images which are augmented from a facial image that causes a failure in emotion recognition. Accordingly, by augmenting features of a facial expression image that causes a failure in prediction through error feedback, facial expression recognition performance can be enhanced.

### CROSS-REFERENCE TO RELATED APPLICATION(S) AND CLAIM OF PRIORITY

This application is based on and claims priority under 35 U.S.C. § 119 to Korean Patent Application No. 10-2022-0174501, filed on Dec. 14, 2022, and Korean Patent Application No. 10-2023-0063708, filed on May 17, 2023, in the Korean Intellectual Property Office, the disclosure of which is herein incorporated by reference in its entirety.

### BACKGROUND

### Field

The disclosure relates to a user emotion prediction method, and more particularly, to a method and a system for predicting emotions of a user by extracting facial expression information from a user image and then using corresponding information.

### Description of Related Art

Related-art emotion prediction technologies are based on image information regarding human faces or biometric signal sensor information such as pulse, brainwave, etc. However, when a user shows little change in the facial expression or intends to conceal his/her emotions, it may be difficult to grasp user's metal state, and, when biometric signal information is used, methods require a cumbersome procedure to attach or detach sensors every time emotions are predicted, and thus there is a demerit that time and costs required increase.

Many researches have shown that human gestures may be important information to understand metal states. For example, leg-shaking and nail-biting may indicate a metal state of being nervous and anxious.

### SUMMARY

The disclosure has been developed in order to solve the above-described problems, and an object of the disclosure is to provide, as a solution for enhancing accuracy in predicting user's emotions, a method and a system for predicting emotions based on virtual facial expression image augmentation, which extract facial expression information from a user image and then use corresponding information.

According to an embodiment of the disclosure to achieve the above-described object, an emotion prediction method may include: a step of acquiring a user facial image; a step of extracting a facial expression feature from the acquired user facial image; and a step of predicting a user emotion from the extracted facial expression feature, and the step of extracting may include extracting the facial expression feature by using a facial expression recognition network, the facial expression recognition network being an artificial intelligence (AI) model that is trained to receive a user facial image and to extract a facial expression feature, and the facial expression recognition network may be retrained with virtual facial images which are augmented from a facial image that causes a failure in emotion recognition.

The step of extracting the facial expression feature may include: a step of extracting a face style feature from the facial image; a step of extracting a facial expression feature from the facial image; and a step of fusing the extracted face style feature and the extracted facial expression feature.

The step of extracting the face style feature may include: a step of generating face mesh data from the facial image; and a step of extracting the face style feature from the generated mesh data.

According to an embodiment of the disclosure, the emotion prediction method may further include a step of generating augmented facial images by using a generation network, the generation network receiving a facial expression feature of a facial image that causes a failure to facial expression recognition, and generating and outputting a virtual facial image.

The generation network may receive a feature into which a facial expression feature and an emotion label are fused, and may generate a virtual facial image. The generation network may constitute a discriminator configured to discriminate whether the virtual facial image generated by the generation network is a real image or a fake image, and a generative adversarial network.

The generation network may be trained to generate a virtual facial image that degrades accuracy of discrimination of the discriminator, and the discriminator may be trained to enhance accuracy of discrimination on whether the virtual facial image generated by the generation network is a real image or a fake image. The generation network may be trained to generate a virtual facial image that has a similarity to a real facial image by a defined level or lower.

A failure in recognition of a facial expression may be grasped through feedback or a response of a user to a service that is provided based on a result of emotion prediction.

According to another embodiment of the disclosure, an emotion prediction system may include: a facial expression recognition unit configured to extract a facial expression feature from a user facial image; and an emotion prediction unit configured to predict a user emotion from the extracted facial expression feature, and the facial expression recognition unit may extract the facial expression feature by using a facial expression recognition network, the facial expression recognition network being an AI model that is trained to receive a user facial image and to extract a facial expression feature, and the facial expression recognition network may be retrained with virtual facial images which are augmented from a facial image that causes a failure in emotion recognition.

According to still another embodiment of the disclosure, a facial expression recognition method may include: a step of acquiring a user facial image; and a step of extracting a facial expression feature from the acquired user facial image, and the step of extracting may include extracting the facial expression feature by using a facial expression recognition network, the facial expression recognition network being an AI model that is trained to receive a user facial image and to extract a facial expression feature, and the facial expression recognition network may be retrained with virtual facial images which are augmented from a facial image that causes a failure in predicting an emotion from an extracted facial expression feature.

As described above, according to embodiments of the disclosure, by augmenting features of a facial expression image that causes a failure in prediction through error feedback, facial expression recognition performance can be enhanced, and through this, a generic-purpose facial expression sorting device can be trained.

According to embodiments, regarding a facial expression image that is difficult for a facial expression recognition device to discriminate, a virtual facial expression image may be generated by using GAN technology, so that facial expression recognition performance can be enhanced. In particular, even when a user shows little change in the facial expression or intends to conceal his/her emotions, it is possible to predict emotions, and accordingly, the method and system according to an embodiment may be used in various application services such medical services, games, simulated interview, etc.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a user facial expression recognition system according to an embodiment of the disclosure;

FIG. 2 is a view to explain a structure of a facial expression recognition network;

FIG. 3 is a view to explain a structure of an emotion prediction network;

FIG. 4 is a view to explain a structure of a virtual facial expression image generation network;

FIG. 5 is a view to explain learning based on a generative adversarial network;

FIG. 6 is a view illustrating examples of virtual facial expression images; and

FIG. 7 is a view illustrating examples of virtual facial expression images.

### DETAILED DESCRIPTION

Hereinafter, the disclosure will be described in more detail with reference to the accompanying drawings.

Embodiments of the disclosure provide an emotion prediction method based on virtual facial expression image augmentation. The disclosure relates to a technology for predicting emotions of a user by continuously extracting facial expression information from an image shot in front of a user and then using corresponding information.

In embodiments of the disclosure, error feedback is applied to a learning framework in recognizing facial expressions. Error feedback makes it possible to recognize a facial expression that is difficult to recognize, by re-extracting features on a facial expression which causes a failure in emotion prediction, and re-training a facial expression recognition network. This method is contrasted to related-art methods of training a facial expression recognition network with given training data (a facial expression, a facial expression label) according to an end-to-end learning scheme.

In addition, in embodiments of the disclosure, a feature augmentation technique is applied in re-training of the facial expression recognition network in order to diversify facial expressions that are difficult to recognize, so that performance degradation caused by the lack of training data may be reduced and facial expressions may be recognized in various environments.

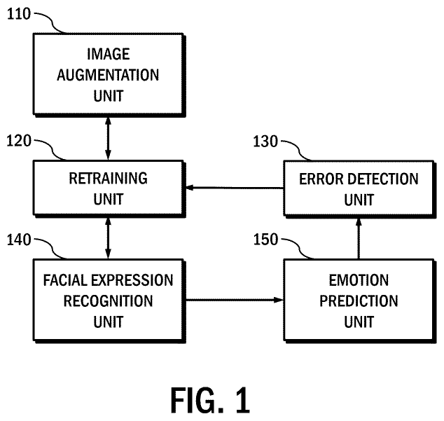

FIG. 1 is a view illustrating a configuration of a user facial expression recognition system according to an embodiment of the disclosure. As shown in FIG. 1, the user facial expression recognition system according to an embodiment may include an image augmentation unit 110, a re-training unit 120, an error detection unit 130, a facial expression recognition unit 140, and an emotion prediction unit 150.

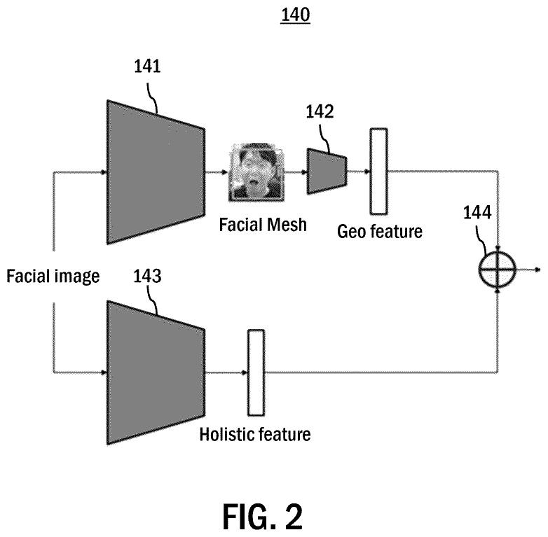

The facial expression recognition unit 140 may extract facial expression feature data from a facial image of a user. A facial image may be acquired by detecting only a facial area from a user image. The facial expression recognition unit 140 may be implemented by a facial expression recognition network, which will be described in detail below with reference to FIG. 2.

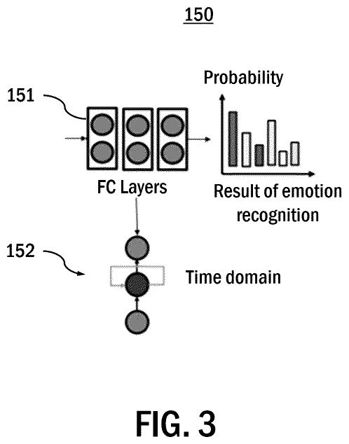

The emotion prediction unit 150 may predict an emotion of a user by analyzing facial expression feature data extracted by the facial expression recognition unit 140. The emotion prediction unit 150 may be implemented by an emotion prediction network, which will be described in detail below with reference to FIG. 3.

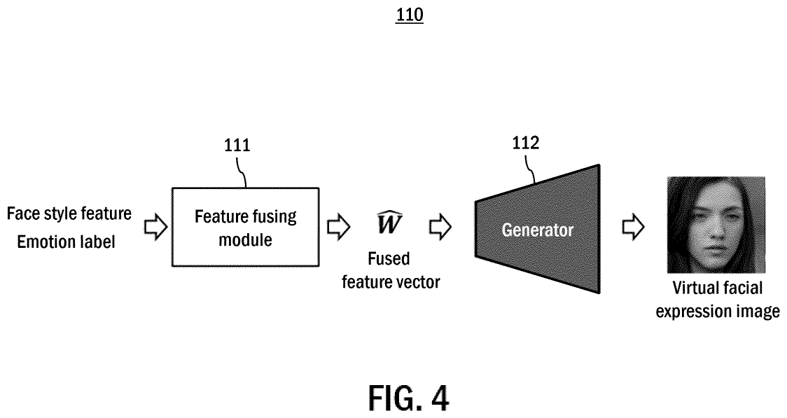

The image augmentation unit 110 may generate virtual facial expression images for retraining the facial expression recognition network. The image augmentation unit 110 may be implemented by a virtual facial expression image generation network, which will be described in detail below with reference to FIG. 4.

The error detection unit 130 may detect whether there is an error in the emotion of the user predicted by the emotion prediction unit 150, that is, whether emotion prediction fails. A failure in emotion prediction may be detected through feedback or a response of the user to a service that is provided based on the result of emotion prediction.

The retraining unit 120 may control generation of a virtual facial expression image of the image augmentation unit 110. Specifically, the retraining unit 120 may cause the image augmentation unit 110 to generate a virtual facial expression image regarding a facial expression that is a basis for erroneously predicting an emotion, that is, causes an error to be detected by the error detection unit 130. In addition, the retraining unit 120 may retrain the facial expression recognition network with virtual facial expression images generated by the image augmentation unit 110.

Hereinafter, a structure of the facial expression recognition network operating in the facial expression recognition unit 140 described above will be described in detail with reference to FIG. 2. As shown in FIG. 2, the facial expression recognition network may include three convolutional neural networks (CNNs) 141, 142, 143 and a fuser 144.

The CNN-1 141 is a network that generates user face mesh data from an inputted user facial image. The CNN-2 142 is a network that extracts a face style feature (geo feature) of the user from the mesh data generated in the CNN-1 141.

The CNN-3 143 is a network that extracts a facial expression feature (holistic feature) from the inputted user facial image.

The fuser 144 may fuse the face style feature extracted at the CNN-2 142 and the facial expression feature extracted at the CNN-3 143. Fusing may be performed not only by concatenating but also by using other functions. Features fused by the fuser 144 may be provided to the emotion prediction unit 150.

The facial expression recognition network may be trained through supervised learning by using a pre-established training dataset for facial expression recognition, and then, may be retrained by adding virtual facial expression images generated in the image augmentation unit 110.

Hereinafter, a structure of the emotion prediction network operating in the emotion prediction unit 150 described above will be described with reference to FIG. 3. As shown in FIG. 3, the emotion prediction network may include fully connected layers (FCL) 151 and a recurrent neural network (RNN) 152.

The FCL 151 and the RNN 152 may receive facial expression feature data extracted in the facial expression recognition unit 140, and may predict an emotion of a user time-continuously and may output the result of predicting. The outputted result of the prediction may be delivered to the error detection unit 130.

The emotion prediction network may be trained through supervised learning by using a pre-established training dataset, and also, may be trained through reinforcement learning.

Hereinafter, a structure of the virtual facial expression image generation network operating in the image augmentation unit 110 described above will be described with reference to FIG. 4. As shown in FIG. 4, the image augmentation unit 110 may include a feature fusing module 111 and a generator 112.

The feature fusing module 111 may fuse a face style feature and an emotion label. Fusing may be performed not only by concatenating but also by using other functions. Features fused by the feature fusing module 111 may be delivered to the generator 112.

The generator 112 is a network that receives features fused by the feature fusing module 111, and generates and outputs a virtual facial image. The generator 112 may be trained by a learning method based on generative adversarial networks (GANs), which is unsupervised learning.

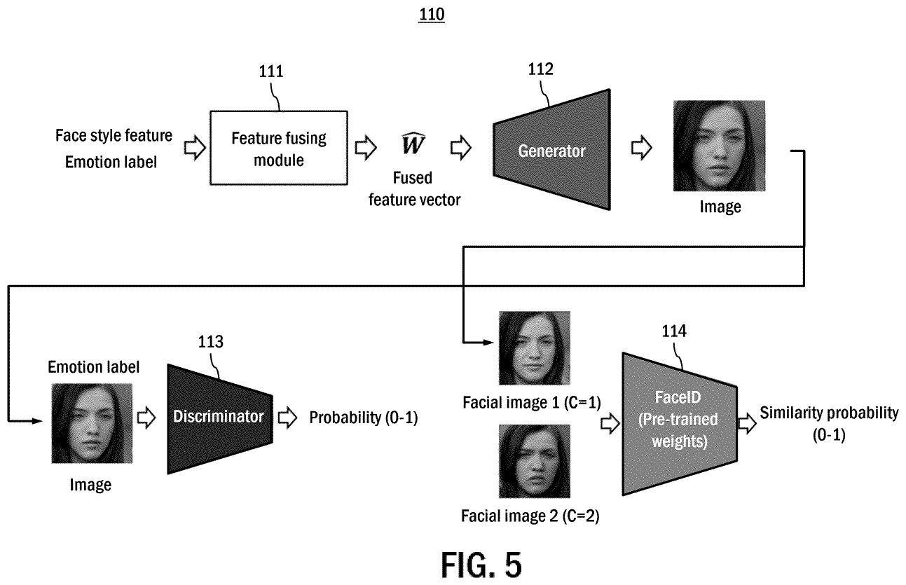

A configuration of the generative adversarial network for this training is illustrated in FIG. 5 in detail. As shown in FIG. 5, the generative adversarial network may include an image augmentation unit 110, a discriminator 113, and an evaluator 114.

The image augmentation unit 110 may generate a virtual facial expression image from a face style feature and an emotion label as described above. The discriminator 113 may identify whether a facial image is a real image or a fake image, based on the inputted facial expression image and emotion label.

1) A real facial expression image from which a face style feature to be inputted to the image augmentation unit 110 is extracted, and an emotion label, and 2) a virtual facial expression image generated by the image augmentation unit 110, and an emotion label may be randomly inputted to the discriminator 113.

In this process, the image augmentation unit 110 may be trained to generate a more accurate virtual facial expression image such that accuracy of discrimination of the discriminator 113 is degraded, that is, it is very difficult to discriminate between a real image and a fake image, and the discriminator 113 may be trained to discriminate a fake image which is a virtual facial expression image generated in the image augmentation unit 110 with a high degree of accuracy.

The evaluator 114 is a network that receives a real facial expression image from which a face style feature to be inputted to the image augmentation unit 110 is extracted, and a virtual facial expression image generated by the image augmentation unit 110, and calculates a similarity therebetween and outputs an outcome.

The image augmentation unit 110 may be trained such that the similarity calculated by the evaluator 114 becomes lower than or equal to a defined level. This configuration is to prevent a virtual facial expression image generated by the image augmentation unit 110 from being very analogous to a real facial expression image.

Training based on the generative adversarial network, illustrated in FIG. 5, is performed with respect to facial expression images that are a basis for erroneously predicting emotions, that is, cause an error to be detected by the error detection unit 130. To accomplish this, the retraining unit 120 may provide face style feature data regarding a facial expression image which causes a failure in emotion prediction, and an emotion label to the image augmentation unit 110, and may retrain the facial expression recognition network with virtual facial expression images and emotion labels generated by the image augmentation unit 110.

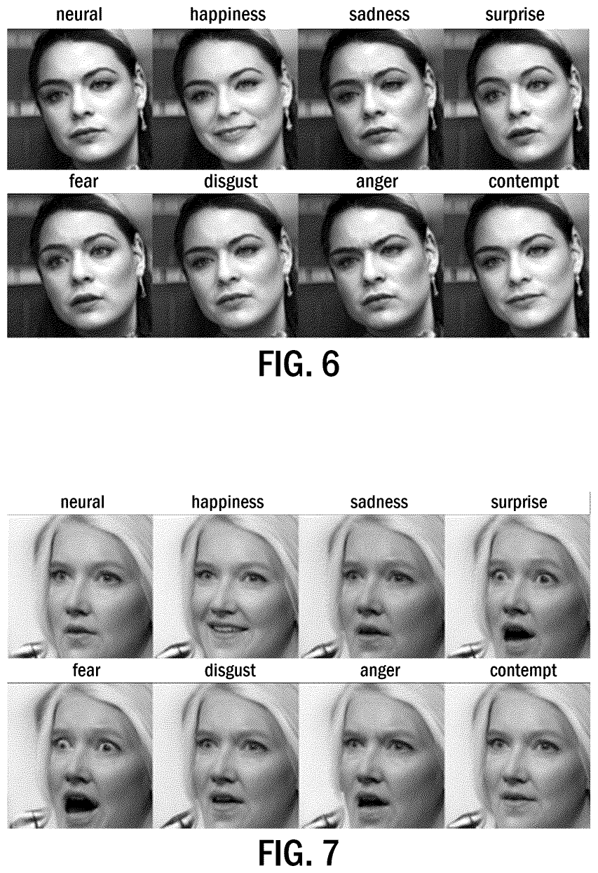

FIG. 6 illustrates examples of virtual facial expression images generated by the image augmentation unit 110, and FIG. 7 illustrates examples of virtual facial expression images generated by the image augmentation unit 110.

Up to now, an emotion prediction method based on virtual facial expression image augmentation has been described with reference to preferred embodiments.

In the above-described embodiments, in grasping changes in a mental state of a user by analyzing a facial expression of the user, features of a facial expression image that causes a failure in prediction may be augmented through error feedback, so that that facial expression recognition performance can be enhanced, and through this, a generic-purpose facial expression sorting device can be trained.

In addition, regarding a facial expression image that is difficult for a facial expression recognition device to discriminate, a virtual facial expression image may be generated by using GAN technology, so that facial expression recognition performance can be enhanced. In particular, even when a user shows little change in the facial expression or intends to conceal his/her emotions, it is possible to predict emotions, and accordingly, the method and system according to an embodiment may be used in various application services such medical services, games, simulated interview, etc.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An emotion prediction method comprising:
a step of acquiring a user facial image;
a step of extracting a facial expression feature from the acquired user facial image; and
a step of predicting a user emotion from the extracted facial expression feature,
wherein the step of extracting comprises extracting the facial expression feature by using a facial expression recognition network, the facial expression recognition network being an artificial intelligence (AI) model that is trained to receive a user facial image and to extract a facial expression feature,
wherein the facial expression recognition network is retrained with virtual facial images which are augmented from a facial image that causes a failure in emotion recognition.

2. The emotion prediction method of claim 1, wherein the step of extracting the facial expression feature comprises:
a step of extracting a face style feature from the facial image;
a step of extracting a facial expression feature from the facial image; and
a step of fusing the extracted face style feature and the extracted facial expression feature.

3. The emotion prediction method of claim 2, wherein the step of extracting the face style feature comprises:
a step of generating face mesh data from the facial image; and
a step of extracting the face style feature from the generated mesh data.

4. The emotion prediction method of claim 1, further comprising a step of generating augmented facial images by using a generation network, the generation network receiving a facial expression feature of a facial image that causes a failure to facial expression recognition, and generating and outputting a virtual facial image.

5. The emotion prediction method of claim 4, wherein the generation network is configured to receive a feature into which a facial expression feature and an emotion label are fused, and to generate a virtual facial image.

6. The emotion prediction method of claim 5, wherein the generation network constitutes a discriminator configured to discriminate whether the virtual facial image generated by the generation network is a real image or a fake image, and a generative adversarial network.

7. The emotion prediction method of claim 6, wherein the generation network is trained to generate a virtual facial image that degrades accuracy of discrimination of the discriminator, and
wherein the discriminator is trained to enhance accuracy of discrimination on whether the virtual facial image generated by the generation network is a real image or a fake image.

8. The emotion prediction method of claim 7, wherein the generation network is trained to generate a virtual facial image that has a similarity to a real facial image by a defined level or lower.

9. The emotion prediction method of claim 1, wherein a failure in recognition of a facial expression is grasped through feedback or a response of a user to a service that is provided based on a result of emotion prediction.

10. An emotion prediction system comprising:
a facial expression recognition unit configured to extract a facial expression feature from a user facial image; and
an emotion prediction unit configured to predict a user emotion from the extracted facial expression feature,
wherein the facial expression recognition unit is configured to extract the facial expression feature by using a facial expression recognition network, the facial expression recognition network being an AI model that is trained to receive a user facial image and to extract a facial expression feature,
wherein the facial expression recognition network is retrained with virtual facial images which are augmented from a facial image that causes a failure in emotion recognition.

11. A facial expression recognition method comprising:
a step of acquiring a user facial image; and
a step of extracting a facial expression feature from the acquired user facial image.
wherein the step of extracting comprises extracting the facial expression feature by using a facial expression recognition network, the facial expression recognition network being an AI model that is trained to receive a user facial image and to extract a facial expression feature,
wherein the facial expression recognition network is retrained with virtual facial images which are augmented from a facial image that causes a failure in predicting an emotion from an extracted facial expression feature.
